(19) United States
(12) Patent Application Publication
(10) Pub. No.: US 2003/0127244 A1
(43) Pub. Date: Jul. 10, 2003

(54) Winding insulation structure for annular coils

(76) Inventor: Albert Cho, Taipei Hsien (TW)

Correspondence Address: BACON & THOMAS, PLLC, 625 SLATERS LANE, FOURTH FLOOR, ALEXANDRIA, VA, 22314

(21) Appl. No.: 10/035,236

(22) Filed: Jan. 4, 2002

(51) Int. Cl. H01B 17/38

(52) U.S. Cl. 174/186

(57) ABSTRACT

A winding insulation structure for shrouding an iron core of coils or coil sets of various stages to provide desired insulation effect includes an inner tube located in an inner annular ring of the iron core or coil sets of various stages, and two elastic caps symmetrically located on two axial sides of the iron core or coil sets of various stages. The inner tube and the two caps can shroud the iron core or coil sets of various stages closely to achieve better insulation effect. The insulation structure also may be assembled rapidly for the annular coils.

### FIELD OF THE INVENTION

The present invention relates to a winding insulation structure for annular coils and particularly a winding insulation structure for speedy assembly of annular coils used on iron cores or coil sets of various stages.

### BACKGROUND OF THE INVENTION

Coils are apparatus for transforming electric energy to magnetic energy, or transforming magnetic energy to electric energy. They are mainly used in motors, generators or transformers. They employ the physical phenomenon of “electricity generates magnetism, and magnetism generates electricity” to perform energy transformation for use in different applications.

In the process of winding a coil, an annular iron core is used as a magnetic flux material, then a coil is wound around the annular iron core. When the coil is energized with electricity, magnetic field can be increased. In order to meet different requirements, the iron core may be wound around with coils of different characteristics. In order to separate the iron core and coils of different stages, the iron core and a coil wound at a stage usually are shrouded by a layer of insulation element to insulate coils of different stages, then coil winding for the following stage may be proceeded.

There are generally two conventional methods being adopted for producing insulation as follows:

1. Winding with insulation adhesive tapes. The coil is wound by insulation tapes layer by layer. In the past, winding process was done manually. It was a time-consuming and costly process. Then automatic winding machines were developed and introduced for winding the adhesive tape mechanically. While they can reduce the production time, the machines are expensive. They are not economically justified for small companies.

2. Shrouding by plastic caps. As shown in FIG. 1, the iron core or coils of various layers are directly shrouded by two symmetrical plastic caps. This method does not need additional production process. Fabrication of insulation can be greatly simplified, and production time can be reduced. Production time is even faster than the method that utilizes automatic winding machines. However it still has some problems remained to be resolved, notably:

a. The plastic caps have normal angles at the bending locations, and cannot shroud the coils closely. As a result, there are gaps and voids in the finished products.

b. The plastic caps are made with fixed dimensions. To shroud coils of different sizes, different sizes of coils are needed and different types of molds should be prepared and made for producing the caps. It is not convenient in practice.

### SUMMARY OF THE INVENTION

The primary object of the invention is to resolve aforesaid disadvantages. The invention aims at providing a winding insulation structure for annular coils that can fabricate insulation rapidly to shorten production time.

Another object of the invention is to provide an insulation structure for shrouding annular coil surfaces closely without producing gaps or voids.

A further object of the invention is to provide an insulation structure that is adaptable to dimension variations without the need of making additional molds to save costs.

To achieve the foregoing objects, the winding insulation structure of the invention includes an inner tube located in an inner annular ring of the iron core or coil sets of various stages, and two elastic caps symmetrically located on two axial sides of the iron core or coil sets of various stages. The cap has a center opening, a first bend section and a second bend section formed respectively on an inner rim and an outer rim of the cap, and a first surrounding section and a second surrounding section extending respectively from the first bend section and the second bend section. The first surrounding section may be housed in the inner tube. The first surrounding section and the second surrounding section form a holding trough therebetween to hold the iron core or coil sets of various stages. The inner tube and the two caps can shroud the iron core or coil sets of various stages closely to achieve better insulation effect. The structure also allows rapid assembly of the insulation for annular coils.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a conventional insulation structure.

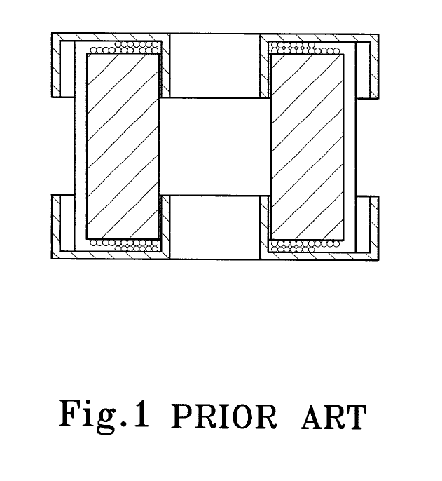

FIG. 2 is an exploded view of the invention.

FIG. 3 is an exploded view of a first embodiment of the invention.

FIG. 4 is a sectional view of the first embodiment of the invention.

FIG. 5 is a sectional view of a second embodiment of the invention.

FIG. 6 is an exploded view of a third embodiment of the invention.

### DESCRIPTION OF THE PREFERRED EMBODIMENTS

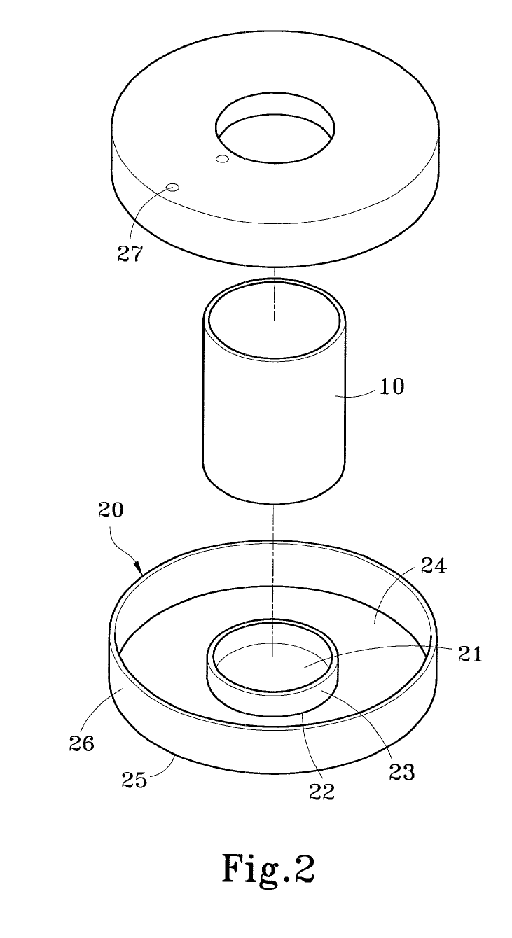

Referring to FIG. 2, the winding insulation structure for annular coils according to the invention is for shrouding an annular iron core (not shown in the drawing) or coil sets of various stages (also not shown in the drawing), and consists of an inner tube 10 located in an inner annular ring of the iron core or coil sets of various stages, and two elastic caps 20 symmetrically located on two axial sides of the iron core or coil sets of various stages. The inner tube 10 and the two caps 20 can shroud the iron core or coil sets of various stages closely to achieve better insulation effect. The structure also allows rapid assembly of the insulation for annular coils.

The cap 20 has a center opening 21, a first bend section 22 and a second bend section 25 formed respectively on an inner rim and an outer rim thereof, and a first surrounding section 23 and a second surrounding section 26 extending respectively from the first bend section 22 and the second bend section 25. The first surrounding section 23 may be housed in the inner tube 10. The first surrounding section 23 and the second surrounding section 26 form a holding trough 24 therebetween to hold the iron core or coil sets of various stages therein to form a complete shrouding for achieving desired insulation effect.

The inner tube 10 may be made of a voltage-resistant, heat-isolating and insulating material. The length of the inner tube 10 is defined based on the axial length of the iron core or coil sets of various stages, and may be covered by the caps 20 from the periphery to complete the production of the insulation.

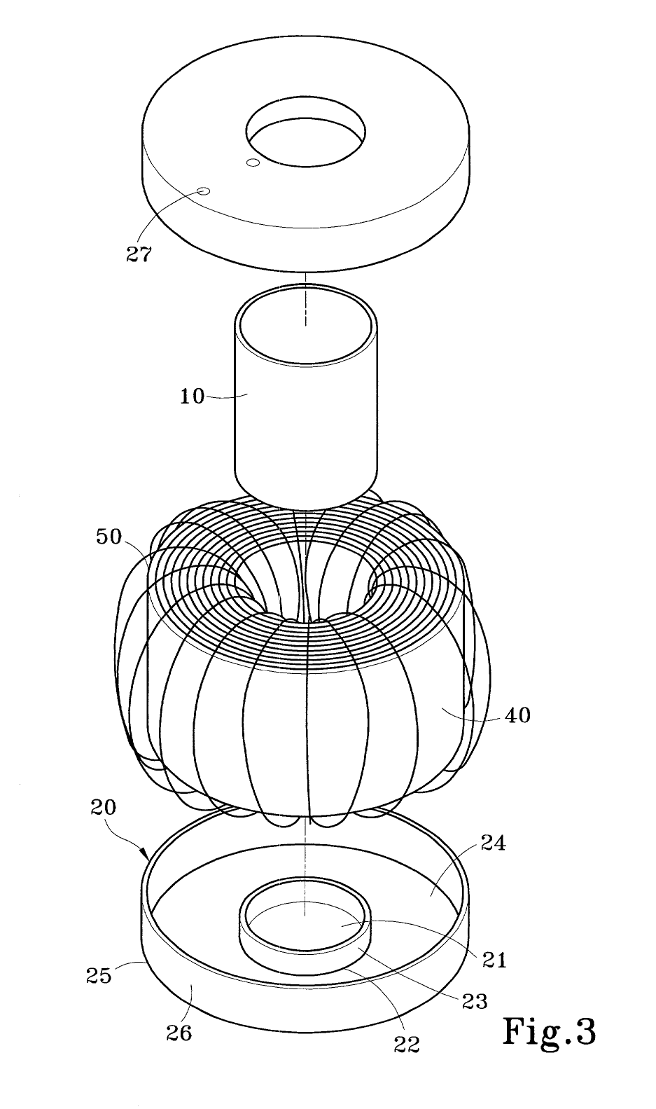

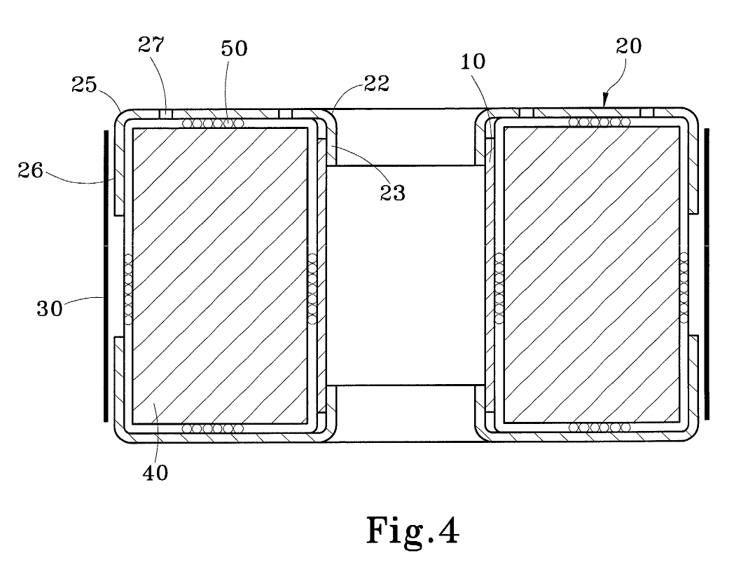

FIGS. 3 and 4 illustrate a first embodiment of the invention for insulating a primary coil set 50. The primary coil set 50 winds around an iron core 40. An inner tube 10 is formed with a length fitting the axial length of the primary coil set 50 and is held in an inner ring of the primary coil set 50. Depending on utilization of the coil, the cap 20 may have two apertures 27 formed thereon for threading respectively a head and a tail leading wire (not shown in the drawings). The two caps 20 are axially mounted on two sides of the primary coil set 50 with the primary coil housed completely in the holding trough 24. The first bend section 22 and the second bend section 25 contact closely the bending portions of the primary coil set 50. The first surrounding section 23 and the second surrounding section 26 surround the inner ring and outer ring of the primary coil set 50. In order to improve insulation quality, a shrouding element 30 may be provided to surround the second surrounding section 26 to achieve a completed sealing and enhance insulation effect.

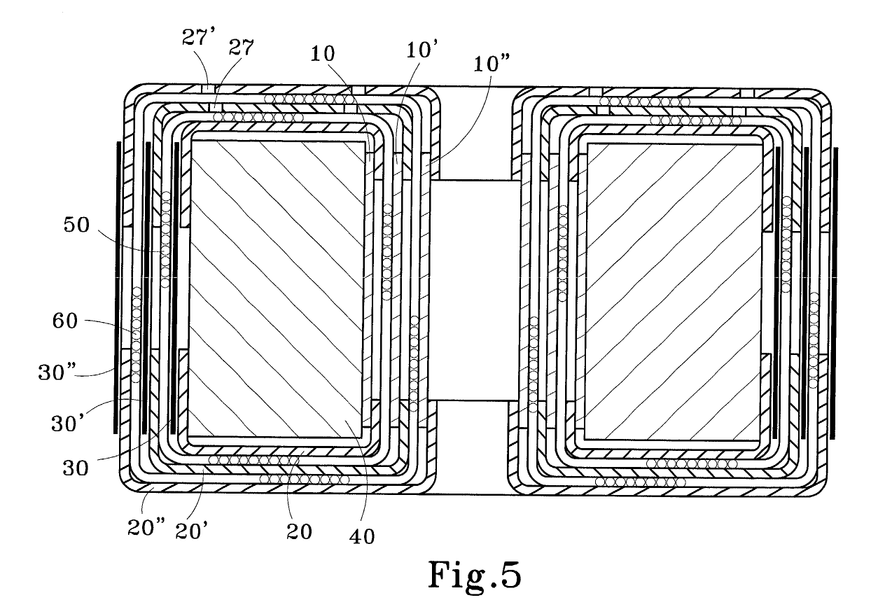

Referring to FIG. 5 for a second embodiment of the invention, the insulation structure of the invention may also be adapted for use on an iron core 40 and a secondary coil set 60. The production process is largely same as the one for the primary coil set 50. There are inner tubes 10, 10′, 10″ which are cut according to desired lengths and are disposed respectively in coil sets of various stages. Then the coils are shrouded respectively by caps 20, 20′, 20″, and then are surrounded respectively by shrouding elements 30, 30′, 30″ over the peripheries thereof. Afterward, leading wires of the coils (not shown in the drawing) are threaded through apertures 27, 27′ to complete the production of the insulation for the iron core 40 and coil sets of various stages.

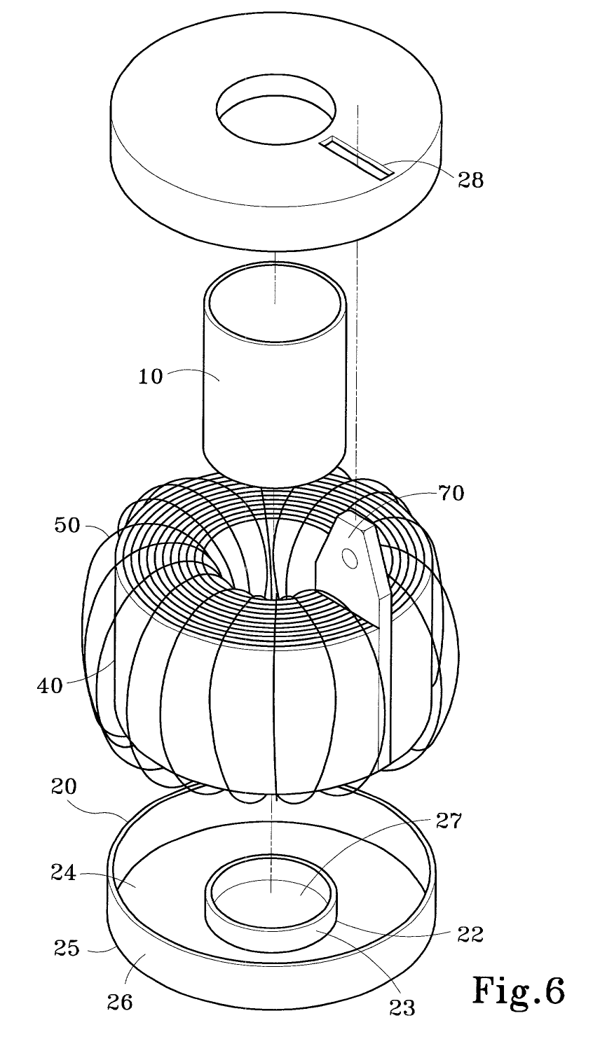

FIG. 6 shows a third embodiment of the invention. In order to make winding of the coils more smoothly, an auxiliary winding block 70 may be wedged in the iron core 40. And a slot 28 may be formed on the cap 20 to allow the auxiliary winding block 70 to pass through to facilitate winding operation for the insulation.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A winding insulation structure for annular coils for shrouding an iron core of the coils or coil sets of various stages wound around the iron core to provide a desired insulation effect, comprising:
an inner tube located in an inner annular ring of the coil sets of various stages; and
two elastic caps symmetrically located on two axial sides of the iron core or the coil sets of various stages, each of the caps having a center opening, a first bend section and a second bend section formed respectively on an inner rim and an outer rim thereof, and a first surrounding section and a second surrounding section extending respectively from the first bend section and the second bend section, the first surrounding section being housed in the inner tube, the first surrounding section and the second surrounding section forming a holding trough therebetween;
wherein the inner tube and the two caps shroud the iron core or the coil sets of various stages therein closely to an insulation structure for the annular coils to achieve rapid assembly and the desired insulation effect.

2. The winding insulation structure of claim 1, wherein the inner tube has an axial length tailored to an axial height of the iron core or the coil sets of various stages.

3. The winding insulation structure of claim 1 further having a shrouding element encasing the second surrounding section to enhance the insulation effect.

4. The winding insulation structure of claim 1, wherein the cap has two apertures for threading respectively a head leading wire and a tail leading wire.

5. The winding insulation structure of claim 1, wherein the cap has a slot for an auxiliary winding block located in the iron core to pass through.

6. The winding insulation structure of claim 1, wherein the first bend section and the second bend section contact closely curved portions of the coils.

7. The winding insulation structure of claim 1, wherein the coil sets of various stages include a primary coil set and a secondary coil set.
